(19) United States
(12) Patent Application Publication
(10) Pub. No.: US 2009/0258123 A1
(43) Pub. Date: Oct. 15, 2009

(54) PROCESS FOR PREPARING PARFRIED POTATOES FOR MICROWAVE HEATING

(75) Inventor: David N. Gallina, Nampa, ID (US)

Correspondence Address: KELLY LOWRY & KELLEY, LLP, 6320 CANOGA AVENUE, SUITE 1650, WOODLAND HILLS, CA, 91367, US

(73) Assignee: J. R. SIMPLOT COMPANY, Boise, ID (US)

(21) Appl. No.: 12/395,260

(22) Filed: Feb. 27, 2009

Related U.S. Application Data
(60) Provisional application No. 61/044,601, filed on Apr. 14, 2008.

(51) Int. Cl. A23L 1/217

(52) U.S. Cl. 426/293; 426/302

(57) ABSTRACT

Potato pieces such as cut potato chunks are pre-processed by blanching, parfrying and freezing, followed by a surface-coating step wherein the potato pieces are coated with a blend of oil and lecithin. In a preferred form, the oil-lecithin blend comprises about 95% weight oil such as a soybean-based salad oil, and about 5% weight soybean-based lecithin. This oil-lecithin blend is applied to the pre-processed potato pieces as by spraying to achieve a product weight increase of from about 2% to about 8%. Such surface-coated frozen potato pieces are adapted for finish preparation by microwave heating, with the finish-prepared pieces exhibiting substantial and desirable external surface crispness in combination with clean and natural potato flavor.

### BACKGROUND OF THE INVENTION

This invention relates generally to an improved process for preparing parfried and frozen potato pieces suitable for finish preparation by microwave heating to exhibit a combination of highly desirable taste, texture and appearance characteristics. More specifically, this invention relates to an improved process and the resultant roasted potato pieces, wherein parfried and frozen potato pieces are surface-coated with a blend of oil and lecithin.

Parfried and frozen potato pieces, such as elongated French fry strips, cube-shaped potato chunks, etc., are widely available in the foods industry. These potato products are conventionally prepared by cutting whole potatoes into individual pieces having a desired size and shape, and then partially cooking the potato pieces by blanching in hot water or steam. Thereafter, the potato pieces are typically dewatered and/or partially dried, followed by partial frying, or parfrying, in hot cooking oil. Batter coatings are sometimes applied before the parfrying step. The parfried potato pieces are then frozen for packaging, shipping and/or storage. Prior to consumption, the parfried and frozen potato pieces are reconstituted or finish prepared typically by finish frying in hot oil, or by alternative processes such as heating in a convection or conventional oven. Parfried and frozen potato pieces of this general type are utilized extensively in restaurant and food service operations, wherein it is desirable to produce a finish-prepared potato product having a substantially optimized set of quality characteristics including substantial external surface crispness or texture, a comparatively more moist product interior having a fresh or natural potato flavor, and a desirable golden brown external appearance.

In the past, these desirable taste and texture characteristics for the finish-prepared potato pieces have generally been incompatible with microwave heating as a means for finish preparation of the potato product. That is, when the parfried and frozen potato pieces are finish prepared by re-heating in a microwave, the resultant potato pieces have generally exhibited undesirable taste and texture characteristics.

More particularly, during frying or parfrying, hot cooking oil at a temperature above the boiling point of water contacts the external surfaces of the individual potato pieces to drive off moisture, resulting in an external crispy surface layer encasing a product interior having a comparatively higher moisture content. During microwave heating for finish preparation, microwave radiation excites and heats water molecules within the interior of each potato piece to cause moisture migration back toward the product external surfaces. As a result, microwave heating tends to equilibrate moisture more uniformly throughout the finish-prepared potato pieces, and thereby creates finish-prepared pieces having limp and soggy, or decidedly non-crispy external surfaces.

Attempts to resolve this problem, namely, limp and soggy external surfaces when the potato pieces are finish prepared by microwave heating, have met with limited success. Such attempts have generally involved extended microwave heating cycles in an effort to re-dry the external surfaces of the potato pieces, but this approach produces a finish-prepared product having a tough and leathery external surface in combination with off-flavor traits such as burnt or cardboard-like flavors. Other attempts have utilized special and typically disposable metallic susceptor boards in contact with the product pieces in a microwave, but such susceptor boards provide inconsistent product crisping typically to include some undesirable product burning, and they also represent a significant increase in overall process cost. Still other approaches have involved extended pre-processing of the product pieces, such as a double parfry process as disclosed in U.S. Pat. No. 4,590,080, which also involves a substantial increase in the overall product processing cost.

There exists, therefore, a need for further improvements in and to processes for economical preparation of parfried potato pieces suitable for finish preparation as by microwave heating, wherein the finish-prepared product exhibits a highly desirable combination of external crispiness, natural potato flavor, and golden brown appearance characteristics. The present invention fulfills these needs and provides further related advantages.

### SUMMARY OF THE INVENTION

In accordance with the invention, potato pieces such as cut potato chunks are conventionally and economically pre-processed by blanching, parfrying and preferably freezing. The thus pre-processed and preferably frozen potato pieces are then externally surface-coated with a blend of oil and lecithin. Such surface-coated frozen potato pieces are adapted for finish preparation by microwave heating, with the finish-prepared pieces exhibiting substantial and desirable external surface crispness in combination with clean and natural potato flavor.

In a preferred form, the oil-lecithin blend comprises a mixture of from about 92% to about 98%, and preferably about 95% by weight oil such as a soybean-based salad oil, and from about 2% to about 8%, and preferably about 5% by weight soybean-based lecithin. This oil-lecithin blend is applied to the pre-processed potato pieces as by dipping or spraying to achieve an overall product weight increase of from about 2% to about 8%, and more preferably about 5%. If desired, the thus-coated potato pieces can then be salted at about 1% by weight, with the external surface-coating assisting in salt distribution and adherence.

In a most preferred pre-processing sequence, blanched potato pieces are contacting with an aqueous solution containing a hydrolyzed starch, such as dextrin or maltodextrin, as described in U.S. Pat. No. 5,302,410, which is incorporated by reference herein. The thus-treated blanched potato pieces are then parfried and preferably frozen, followed by the surface-coating step with the oil-lecithin blend as described above. In one alternative form, the oil-lecithin surface coating is applied after parfrying and before a subsequent freezing step.

The surface-coated frozen potato pieces are held in a frozen state awaiting finish preparation as by microwave heating. When finish prepared, the heated potato pieces exhibit substantial external crispness in combination with a moist and mealy interior. In addition, the heated potato pieces exhibit fresh or natural potato flavor, substantially without attributes of cardboard flavor encountered with prior art microwavable potato products.

Other features and advantages of the present invention will become apparent from the following more detailed description.

### DETAILED DESCRIPTION OF THE PREFERRED EMBODIMENTS

The present invention relates to an improved process for preparing parfried and frozen potato pieces, such as cube-like potato chunks, wherein these potato pieces are suitable for finish preparation by heating in a microwave oven. The finish-prepared potato pieces, processed according to the invention, exhibit substantial and desirable external surface crispness in combination with clean and natural potato flavor.

In general, the parfried and frozen potato pieces are pre-processed in accordance with conventional and relatively economical pre-processing techniques, including initial cutting from raw peeled or unpeeled potatoes, blanching, parfrying, and freezing. More particularly, as is known in the potato processing industry, the raw cut potato pieces are typically blanched in hot water or steam, followed by dewatering and/or partial drying. A batter coating, such as an aqueous-based batter may then be applied to the potato pieces. The potato pieces are then subjected to a partial frying, or parfrying step, followed by freezing for storage and/or shipment.

When finish preparation is desired for product consumption, the frozen potato pieces have been in the past finish fried in hot oil. Alternative finish preparation processes are also known and used, such as heating in a convection or conventional oven, grilling, etc.

The cut potato pieces may comprise any selected cut size and shape, ranging from generally cube-shaped or cube-like potato chunks to wedge shapes and elongated French fry or steak fry strips having selected cross sectional dimensions.

In accordance with the invention, the pre-processed potato pieces which have been parfried and preferably frozen are surface-treated or surface-coated with an oil-lecithin blend which has been found to provide special benefits when the potato pieces are finish prepared by heating with microwave radiation. In this regard, the parfried potato pieces generally exhibit a light and golden brown color defined by an external or exterior surface having a crispy yet tender texture. This crispy external surface is created during parfrying, as moisture located at or near the external surface is rapidly vaporized and driven off by the hot cooking oil. This crispy external surface encases a comparatively more moist and mealy product interior. Upon finish preparation in a microwave, the microwave radiation tends to cause moisture migration from the more-moist product interior toward and to the product exterior, whereby prior microwave-heated potato products have exhibited a limp and soggy external surface attributable to the increased moisture level. Prior attempts to resolve this problem by increased microwave heating time has undesirably resulted in creating a tough and leathery external surface in combination with creating off flavors for the potato pieces, such as burned or cardboard flavors.

By coating the external surfaces of the potato pieces with the oil-lecithin blend of the present invention, it has been found that external surface crispness is substantially maintained while creation of undesirable off flavor attributes is substantially avoided.

In a preferred form, the oil-lecithin blend comprises a mixture of from about 92% to about 98% by weight, and more preferably about 95% by weight oil such as a soybean-based liquid salad oil, in combination with from about 2% to about 8% weight, and more preferably about 5% by weight soybean-based liquid lecithin. Such oil-lecithin blend may be prepared on-site, or alternately obtained from Solae, LLC, dba The Solae Company, St. Louis, Mo., under the product designation Solec WV.

This oil-lecithin blend or mixture is applied to the pre-processed potato pieces, preferably after parfrying and freezing, as by dipping or spraying the potato pieces to achieve an overall product weight increase of from about 2% to about 8% by weight, and more preferably about 5% by weight. In one preferred form, the oil-lecithin blend is sprayed onto the frozen potato pieces. In one alternative preferred form, the oil-lecithin blend at about room temperature is sprayed onto the relatively warm potato pieces exiting the parfry step, and prior to a subsequent freezing step. In either process, the thus surface-coated potato pieces are then salted at a rate of about 1% by weight, with the external surface-coating assisting in salt distribution and adherence.

The potato pieces are then returned to frozen storage, or are otherwise frozen, for appropriate packaging, storage, and/or shipment to a restaurant or other food preparation facility. When desired, the potato pieces are finish prepared by heating in a microwave oven for a selected time and at a selected power setting sufficient to produce fully heated and cooked product interiors. At the conclusion of the microwave finish preparation step, the potato pieces exhibit a highly desirable crispy exterior surface of light and golden brown color. In addition, the finish prepared potato pieces exhibit a comparatively moist and mealy interior similar to potato pieces which have been finish prepared by frying in hot oil. The finish prepared potato pieces further posses a clean and natural potato flavor, substantially in the absence of off flavor traits normally associated with microwave finish preparation.

Byway of one specific example embodying the invention, raw potatoes were cut into cube-like potato chunks having an average chunk size of about 5/16¾×¾ inch. These raw cut potato chunks were then pre-processed generally in accordance with U.S. Pat. No. 5,302,410, which is incorporated by reference herein. More particularly, the raw cut potato chunks were blanched in hot water at a temperature of about 170 F. for about 5 minutes, wherein the blanching medium was pH adjusted to a range of from about 7 to about 7.5. The blanched potato chunks were then dewatered and partially dried at an air temperature of about 150 F. for about 5 minutes, followed by contacting the blanched chunks with an aqueous medium including a hydrolyzed starch product such as dextrin or, more preferably, maltodextrin at a concentration of from about 5% to about 6% by weight. The thus-treated potato chunks were then parfried in hot oil at a temperature of about 385 F. for about 1 minute. The parfried potato chunks were then frozen in a blast freezer at a temperature of about −20 F.

The parfried and frozen potato chunks were then surface-coated as by spraying the above-discussed oil-lecithin blend or mixture at about room temperature to achieve a product weight gain of about 5%. Optional salt was then applied at a rate of about 1% by weight. The surface-coated frozen potato chunks were then packaged and stored or shipped in the frozen state.

The frozen, surface-coated potato chunks were finish prepared in a microwave oven by heating 3 ounces at a power setting of about 1,100 watts, for about 2 minutes. The microwave-heated potato chunks exhibited a desirably crispy and tender exterior surface encasing a comparatively moist and slightly fluffy interior—similar to products which have been finish prepared by frying in hot oil. In addition, the microwave-heated potato chunks exhibited a desirable fresh and clean potato flavor, substantially in the absence of off-flavor traits commonly associated with microwave-prepared potato products.

Although an embodiment has been described in detail for purposes of illustration, various modifications may be made without departing from the scope and spirit of the invention. In this regard, while the preferred embodiment is described in connection with potato pieces such as chunks, persons skilled in the art will understand and appreciate that alternative potato piece shapes including but not limited to wedges and elongated French fry and/or steak fry strips may also be used. Accordingly, no limitation on the invention is intended by way of the foregoing description and accompanying drawings, except as set forth in the appended claims.

What is claimed is:

1. In a process for parfrying and freezing potato products for subsequent finish preparation by microwave heating, said process including the steps of blanching potato products in hot water or steam, parfrying the blanched potato products in hot oil, and freezing the parfried potato products, the improvement comprising:
surface-coating the parfried potato products with an oil-lecithin blend to achieve an overall potato product weight increase of from about 2% to about 8% by weight.

2. The process of claim 1 including the step of coating the potato strips with a liquid batter prior to said parfrying step.

3. The process of claim 1 wherein the potato products comprise French fry potato chunks.

4. The process of claim 1 wherein said surface-coating step comprises dipping the parfried potato products into the oil-lecithin blend.

5. The process of claim 1 wherein said surface-coating step comprises spraying the parfried potato products with the oil-lecithin blend.

6. The process of claim 1 wherein said surface-coating step applies the oil-lecithin blend onto the parfried potato products, prior to said freezing step.

7. The process of claim 1 wherein said surface-coating step applies the oil-lecithin blend onto the frozen parfried potato products.

8. The process of claim 1 wherein the oil-lecithin blend is applied to achieve an overall potato product weight increase of about 5% by weight.

9. The process of claim 1 wherein the oil-lecithin blend comprises from about 92% to about 98% by weight oil, and from about 2% to about 8% by weight lecithin.

10. The process of claim 9 wherein said oil comprises a soybean-based liquid salad oil, and wherein said lecithin comprises a soybean-based liquid lecithin.

11. The process of claim 9 wherein said oil-lecithin blend comprises about 95% by weight soybean-based liquid salad oil, in combination with about 5% by weight soybean-based liquid lecithin.

12. The process of claim 1 further comprising the step of salting the surface-coated potato products, said salting step comprising adding salt to the surface-coated potato products at about 1% by weight.

13. The process of claim 2 wherein said liquid batter includes a hydrolyzed starch.

14. The process of claim 13 wherein said hydrolyzed starch comprises a dextrin.

15. The process of claim 14 wherein said hydrolyzed starch comprises maltodextrin at a concentration of from about 5% to about 6% by weight.

16. The process of claim 1 further comprising the step of finish preparing the surface-coated frozen potato products by microwave heating.

17. A process for parfrying and freezing potato products, said process comprising the steps of:
blanching potato products in hot water or steam at a pH within a range of from about 7.0 to about 7.5;
partially drying the blanched potato products;
contacting the partially dried potato products with an aqueous medium including a hydrolyzed starch product;
parfrying the coated potato products in hot oil; and
freezing the parfried potato products;
wherein said process further comprises surface-coating the parfried potato products with an oil-lecithin blend including from about 92% to about 98% by weight oil and from about 2% to about 8% by weight lecithin, to achieve a product weight gain of from about 2% to about 8%; and
finish preparing the surface-coated frozen potato products by microwave heating.

18. The process of claim 17 wherein the potato products comprise potato chunks.

19. The process of claim 17 wherein said surface-coating step applies the oil-lecithin blend to the frozen parfried potato products.

20. The process of claim 17 further comprising the step of salting the surface-coated potato products.
